(19) United States
(12) Patent Application Publication
(10) Pub. No.: US 2014/0231465 A1
(43) Pub. Date: Aug. 21, 2014

(54) PUMPING-TYPE TUBE CONTAINER

(71) Applicant: YONWOO CO., LTD., Incheon (KR)

(72) Inventor: Seong-Woong Choi, Incheon (KR)

(21) Appl. No.: 14/342,640

(22) PCT Filed: Sep. 18, 2012
(86) PCT No.: PCT/KR2012/007429

§ 371 Date: Mar. 4, 2014

(30) Foreign Application Priority Data
Sep. 29, 2011 (KR) 10-2011-0098868

(51) Int. Cl. G01F 11/00

(52) U.S. Cl. CPC B05B 11/3001
USPC 222/321.9

(57) ABSTRACT

A pumping-type tube container includes a suction pipe which is extended downwardly from the pumping member and has a lower end dipped into the content contained in the tube container, thus minimizing idle operation during a pumping operation of a pumping member and providing user convenience.

### BACKGROUND

The present invention relates to a pumping-type tube container, and in particular to a pumping-type tube container which makes it possible to greatly reduce an idle operation during a pumping wok of a pumping member by providing a suction pipe which extends in a downward direction of a pumping member with its end portion dipped in contents, so a user can more comfortably use the products.

A pumping-type tube container is configured in such a way that a pumping member is disposed at the top of a tube body which contains contents, and the contents can be discharged to the outside through a pumping operation of a pumping member. As shown in FIGS. 1 and 2, the above mentioned pumping-type tube container comprises a tube body 10 made in a tube type and storing contents, a tube neck 20 which is engaged to the top of the tube body 10 and supports the tube body 10 and is equipped with a discharge part through which to discharge contents, a support body 30 which is engaged to the tube neck 20 while supporting the pumping member 40, and an over cap 60 which covers the pumping member 40 and is detachably engaged to the support body 30.

As shown in FIG. 1, the conventional pumping type tube container has features in that the contents are filled in the tube body 10 in a state that the tube body 10 is made upside down, and the end portion 11 is sealed, and the manufacture is finished. If the sealing work is performed after the contents are filled up to its top, the tube body 10 may overflow, and the overflowing contents may spoil the sealing surface, which makes hard to seal the end portions during the sealing work.

For the above mentioned problems, the contents are filled to the extent that a certain volume can be obtained for the sake of easier sealing work.

When the container stands upright after the contents are filled, and the sealing work is finished, as shown in FIG. 2, a space in which the contents are no more filled for the sake of sealing work is formed in the tube body 10. For this configuration, an idle operation occurs during the operation of the pumping member 40 when discharging the contents, so the contents cannot be well discharged. For better discharge of the contents, the user needs to perform more pumping operations, which causes much inconveniences.

### SUMMARY OF THE INVENTION

Accordingly, the present invention is made so as to improve the above mentioned problems. It is an object of the present invention to provide a pumping-type tube container which makes it possible to greatly reduce an idle operation during a pumping wok of a pumping member by providing a suction pipe which extends in a downward direction of a pumping member with its end portion dipped in contents, so a user can more comfortably use the product.

To achieve the above object, there is provided a pumping-type tube container formed of a tube body which is formed in a tube shape and stores contents, a tube neck which is engaged to the top of the tube body and supports the tube body, a support body which is engaged to the tube neck and supports the pumping member, and a pumping member which is supported by the support body and performs a pumping operation so that the contents communicating with the tube body and stored in the tube body can be discharged to the outside, comprising:

a suction pipe which is provided at the bottom of the pumping member and extends in a downward direction of the pumping member and sucks in contents, the lower end portion of the suction pipe being dipped in the contents.

In addition, to achieve the above object, there is provided a pumping-type tube container formed of a tube body which is formed in a tube shape and stores contents, a tube neck which is engaged to the top of the tube body and supports the tube body, a support body which is engaged to the tube neck and supports the pumping member, and a pumping member which is supported by the support body and performs a pumping operation so that the contents communicating with the tube body and stored in the tube body can be discharged to the outside, comprising:

an engaging part which is provided at the bottom of the pumping member and extends in a downward direction of the pumping member; and a suction pipe which is engaged to the engaging part and sucks in contents, the lower end portion of the suction pipe being dipped in the contents.

In addition, the suction pipe has a length long enough for the lower end portion of the suction pipe to dip in the contents in a state that the tube body is obliquely sloped, and the length “L1” of the lower end portion of the suction pipe dipped in the contents is shorter than the length “L2” of the suction pipe which is not dipped in the contents.

According to the present invention, an idle operation can be minimized during a pumping operation of a pumping member by providing a suction pipe which extends in a downward direction of a pumping member with its end portion dipped in contents, so a user can more comfortably use the product.

Since the suction pipe dipped in the contents has an optimized length, it is possible to smoothly discharge contents even in a state that the tube body is sloped at a certain angle while saving manufacture materials.

### BRIEF DESCRIPTION OF DRAWINGS

FIGS. 1 and 2 are cross sectional views illustrating a construction of a conventional pumping type tube container.

FIG. 3 is a perspective view illustrating a construction of a pumping-type tube container according to a preferred embodiment of the present invention.

FIG. 4 is a view illustrating a use state of a pumping-type tube container according to a preferred embodiment of the present invention.

FIG. 5 is a perspective view illustrating a construction of a pumping-type tube container according to another embodiment of the present invention.

FIG. 6 is a view illustrating a use state of a pumping-type tube container according to another embodiment of the present invention.

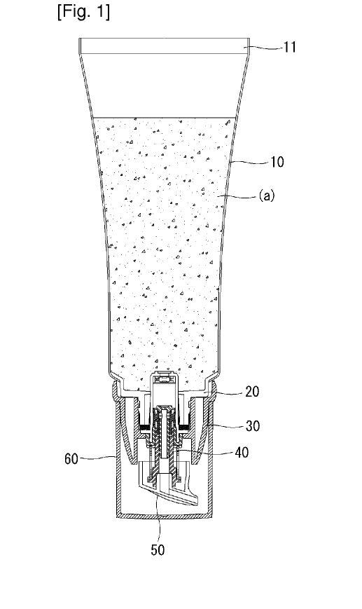

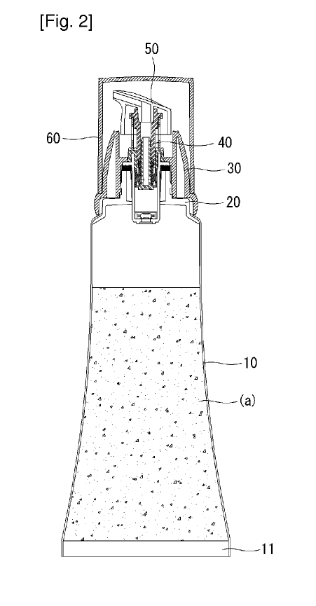

### DETAILED DESCRIPTION OF THE INVENTION

The present invention will be described with reference to the accompanying drawings. The same reference numerals in each drawing mean the same elements.

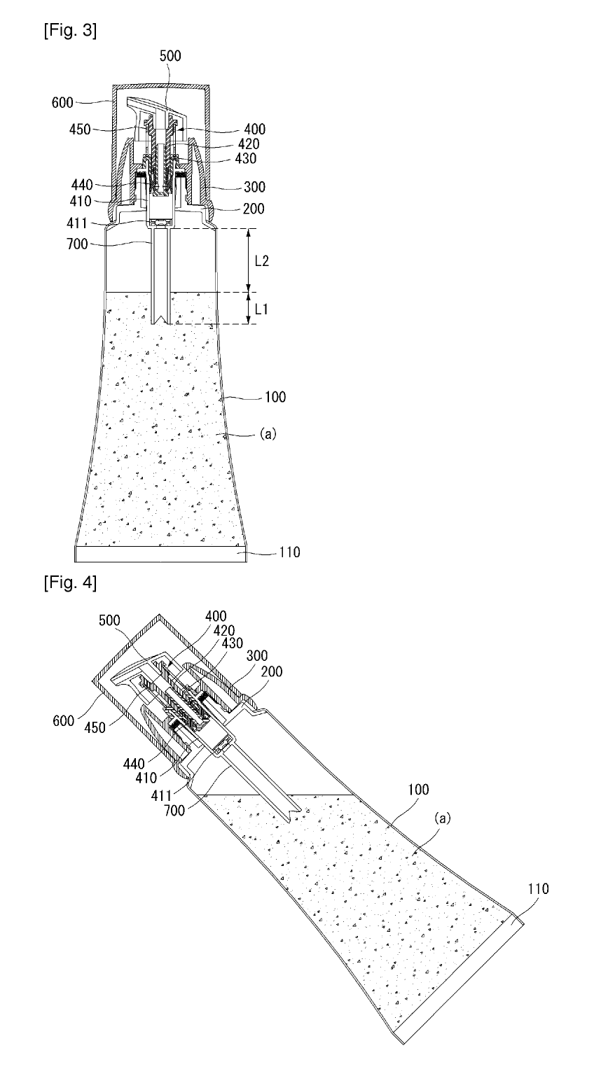

FIG. 3 is a perspective view illustrating a construction of a pumping-type tube container according to a preferred embodiment of the present invention. FIG. 4 is a view illustrating a use state of a pumping-type tube container according to a preferred embodiment of the present invention.

As shown in FIGS. 3 and 4, the pumping-type tube container according to a preferred embodiment of the present invention comprises a tube body 100, a tube neck 200, a support body 300, a pumping member 400, button part 500, an over cap 600 and a suction pipe 700.

The tube body 100 is made in a tube shape for containing a content “a” and is equipped with a space in which to store the content “a” and a sealing part 110 the bottom of which is sealed in a state that the content “a” is filled.

The tube neck 200 is engaged to the top of the tube body 100 and supports the tube body 100 and is preferably hollow in its inner center for the engagement of the pumping member 400.

The support body 300 is engaged to the tube neck 200 and supports the pumping member 400, an over cap 600 being engaged to its outer side so as to prevent errors in the operation of the button part 500.

The pumping member 400 is supported by the support body 300 and communicates with the tube body 100 and performs a pumping operation so that the contents held in the tube body 100 can be discharged to the outside. The pumping member 400 comprises a pump housing 410 engaged to the hollow portion of the tube neck 200 and equipped with a check valve 411 at its inner lower side, a stem 420 one side of which is engaged to the inner side of the button part 500 and the other side of which is positioned at the inner side of the pump housing 410, the stem 420 moving along with the up and down movements of the button part 500, a piston rod 430 engaged to the bottom of the stem 420, a seal cap 440 which is engaged covering the outer circumferential surface of the piston rod 430 at the bottom of the piston rod 430 and moves along the inner wall of the pump housing 410, and a spring 450 which is engaged covering the surroundings of the stem 420 and provides an upward elastic force for the sake of repeated pumping of the button part 500.

The button part 500 is engaged to the top of the stem 420 of the pumping member 400 and ascends and descends based on the press of the user and allows the pumping member 400 to perform a pumping operation.

The over cap 600 covers the support body 300 and the button part 500 and is detachably engaged to the support body 300. The over cap 600 is engaged to the support body 300 when in not use, while preventing the errors of the button part 500, and when in use, it separates from the support body 300 and allows the pumping operation to be performed based on the pressurization of the button part 500.

The suction pipe 700 extends in a downward direction of the pumping member 400 at the bottom of the pumping member 400 for thereby sucking in the contents. In the present invention, the suction pipe 700 extends downward from the bottom of the pump housing 410 so that the bottom of the suction pipe 700 is dipped in the contents.

The suction pipe 700 is configured in such a way that its lower end is dipped in the contents stored in the tube body 100, so the contents “a” can be directly sucked into the interior of the suction pipe 700 during the initial pumping of the pumping member 400, thus minimizing idle operations.

The suction pipe 700 is formed short and is not dipped in the contents “a”, idle operations occur a lot when sucking the contents into the suction pipe 700 during the pumping of the pumping member 400. When it is formed longer, the idle operation also occurs as often as the length of the suction pipe 700 during the pumping of the pumping member 400, so it is most preferred to provide an optimized length of the suction pipe 700.

As shown in FIG. 4, the suction pipe 700 is formed with a length long enough to keep the lower end of the suction pipe 700 dipped in the contents so that the contents “a” can be smoothly discharged when using the product in a state that the user slopes the tube body 100 at a certain angle. As shown in FIG. 3, it is preferred that the length “L1” of the lower end of the suction pipe 700 dipped in the contents is shorter than the length “L2” of the suction pipe 700 which is not dipped in the contents, more specifically, the suction pipe 700 has an optimized length, not too long, not too short.

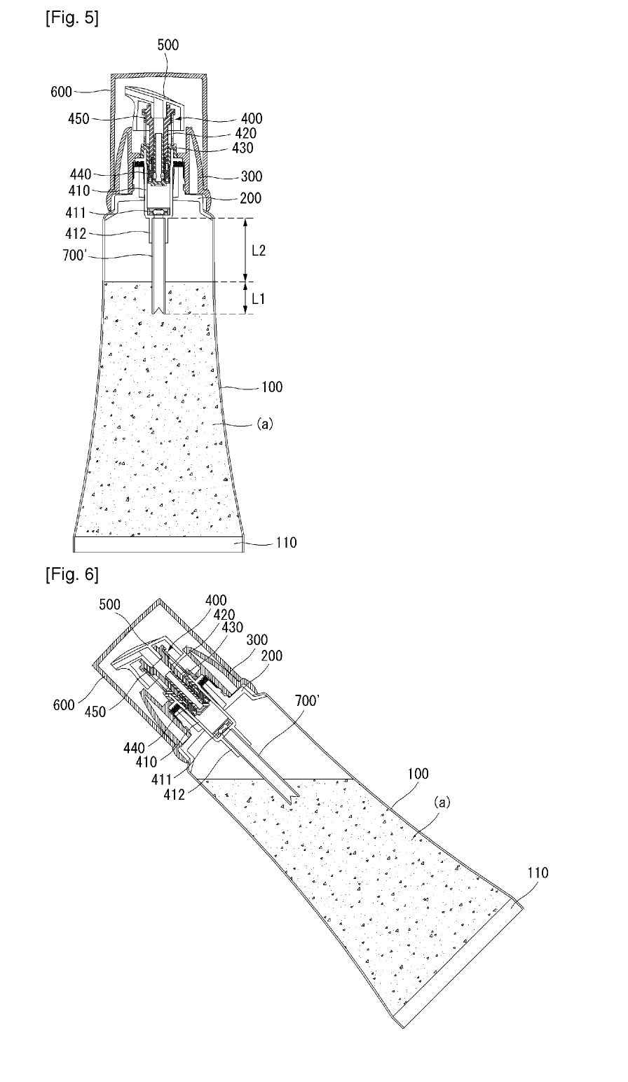

The pumping-type tube container according to another embodiment of the present invention will be described with reference to FIGS. 5 and 6.

FIG. 5 is a perspective view illustrating a construction of a pumping-type tube container according to another embodiment of the present invention. FIG. 6 is a view illustrating a use state of a pumping-type tube container according to another embodiment of the present invention.

As shown in FIGS. 5 and 6, the pumping-type tube container according to another embodiment of the present invention comprises an engaging part 412 which supports a suction pipe 700′ extending downward from the bottom of the pumping member 400 and sucking the contents . The engaging part 412 extends downward from the bottom of the pump housing 410 while covering and supporting the top of the suction pipe 700′, so the suction pipe 700′ is prevented from moving into the interior of the tube body 100 in the middle of engaging the suction pipe 700′.

Since the remaining constructions are same as the earlier described constructions of the embodiments of the present invention, the detailed descriptions will be omitted.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A pumping-type tube container formed of a tube body which is formed in a tube shape and stores contents, a tube neck which is engaged to the top of the tube body and supports the tube body, a support body which is engaged to the tube neck and supports the pumping member, and a pumping member which is supported by the support body and performs a pumping operation so that the contents communicating with the tube body and stored in the tube body can be discharged to the outside, comprising:
a suction pipe which is provided at the bottom of the pumping member and extends in a downward direction of the pumping member and sucks in contents, the lower end portion of the suction pipe being dipped in the contents.

2. A pumping-type tube container formed of a tube body which is formed in a tube shape and stores contents, a tube neck which is engaged to the top of the tube body and supports the tube body, a support body which is engaged to the tube neck and supports the pumping member, and a pumping member which is supported by the support body and performs a pumping operation so that the contents communicating with the tube body and stored in the tube body can be discharged to the outside, comprising:
an engaging part which is provided at the bottom of the pumping member and extends in a downward direction of the pumping member; and
a suction pipe which is engaged to the engaging part and sucks in contents, the lower end portion of the suction pipe being dipped in the contents.

3. The container of claim 1, wherein the suction pipe has a length long enough for the lower end portion of the suction pipe to dip in the contents in a state that the tube body is obliquely sloped, and the length “L1” of the lower end portion of the suction pipe dipped in the contents is shorter than the length “L2” of the suction pipe which is not dipped in the contents.

4. The container of claim 2, wherein the suction pipe has a length long enough for the lower end portion of the suction pipe to dip in the contents in a state that the tube body is obliquely sloped, and the length “L1” of the lower end portion of the suction pipe dipped in the contents is shorter than the length “L2” of the suction pipe which is not dipped in the contents.
